(19) United States
(12) Patent Application Publication
(10) Pub. No.: US 2021/0065692 A1
(43) Pub. Date: Mar. 4, 2021

(54) System for determining intent through prosodic systems analysis and methods thereof

(71) Applicants: Kyle Barker, Surrey (CA); Abid Shah, Burnaby (CA)

(72) Inventors: Kyle Barker, Surrey (CA); Abid Shah, Burnaby (CA)

(21) Appl. No.: 16/558,323

(22) Filed: Sep. 3, 2019

(51) Int. Cl. G10L 15/18; G10L 25/63

(52) U.S. Cl. CPC G10L 15/1807; G10L 25/63

(57) ABSTRACT

The present invention discloses a system for carrying out voice pattern recognition and a method for achieving same. The system includes an arrangement for acquiring an input voice for performing a prosodic analysis of the speech data. The invention quantifies unstructured signal data—like speech/audio and video and translates them into visual indicators that represent the current emotion/sentiment state of parties involved and also presents one side with potential actions that can be taken to move the emotion/sentiment towards ones that are more conducive to the goals of a given project, program, or implementation.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention relates to a system and method for extracting and using prosody features of a human voice, for the purpose of enhanced voice pattern recognition and the ability to output prosodic features to an end user application.

### Description of the Related Art

Our voice is so much than words; voice has intonations, intentions, patterns and this makes us truly unique in our communication. Unfortunately, all this is completely lost when we interact through today's speech recognition tools.

The term “Prosody” refers to the sound of syllables, words, phrases, and sentences produced by pitch variation in the human voice. Prosody may reflect various features of the speaker or the utterance: the emotional state of the speaker; the form of the utterance (statement, question, or command); the presence of irony or sarcasm; emphasis, contrast, and focus; or other elements of language that may not be encoded by the grammar or choice of vocabulary. In terms of acoustics attributes, the prosody of oral languages involves variation in syllable length, loudness and pitch. In sign languages, prosody involves the rhythm, length, and tension of gestures, along with mouthing and facial expressions. Prosody is typically absent in writing, which can occasionally result in reader misunderstanding. Orthographic conventions to mark or substitute for prosody include punctuation (commas, exclamation marks, question marks, scare quotes, and ellipses), and typographic styling for emphasis (italic, bold, and underlined text).

Prosody features involve the magnitude, duration, and changing over time characteristics of the acoustic parameters of the spoken voice, such as: Tempo (fast or slow), timbre or harmonics (few or many), pitch level and in particular pitch variations (high or low), envelope (sharp or round), pitch contour (up or down), amplitude and amplitude variations (small or large), tonality mode (major or minor), and rhythmic or non rhythmic behavior.

U.S. Pat. No. 8,566,092 B2 discloses a method and apparatus for extracting a prosodic feature and applying the prosodic feature by combining with a traditional acoustic feature.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, and abstract as a whole.

The primary desirable object of the present invention is to provide a novel and improved way in which during voice-based interactions, the system listens to the intonation of the speakers and the way specific words are pronounced in order to attach a specific emotion to each tone.

It is another objective of the system which provides recommended actions to one side of the voice interaction that allows the 1st party to dictate and direct the flow of conversation to change or maintain the emotion being expressed.

It is further the objective of the invention to establish in this portion of the disclosure that the present invention is the system which provides 1st party with an easy-to-interpret visual representation of actions being suggested and then taken by 1st party.

It is also the objective of the invention that due to the content being analyzed by the system are language agnostic.

It is another objective of the invention is receiving speech data from the user, performing a prosodic analysis of the speech data, and controlling the virtual agent movement according to the prosodic analysis.

Being able to control the facial expressions and head movements automatically, without having to interpret the text or the situation, opens for the first time the possibility of creating photo-realistic animations automatically. For applications such as customer service, the visual impression of the animation has to be of high quality in order to please the customer. Many companies have tried to use visual text-to-speech in such applications, but failed because the quality was not sufficient.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

One aspect of the present application is directed to invent a voice-based interactions, the system listens to the intonation of the speakers and the way specific words are pronounced in order to attach a specific emotion to each tone.

Certain embodiments of the present invention seek to use a computerized enterprise's knowledge of the user and his problems in order to direct the conversation in a way that will meet their business goals and policies.

The system can be used in the various fields for variety of reasons such as:
a. Marketing, Sales, and Customer Service
   i. Voice stress analytics in customer service
      1. Scans all calls to help facilitate positive customer service interactions through sentiment/emotion manipulation
   ii. Marketing lead pre-screening
      1. Verify legitimacy of interest in any product/service
      2. Verify information provided by prospects
   iii. Call centre performance optimization
      1. scans all calls to identify the ones that are mishandled (real-time or post-call)
      2. post-call performance review (patronizing, antagonistic etc)
      3. guide and change call centre script ‘on the fly’ to adjust according to personality and feedback
      4. customer dissatisfaction analysis
   iv. Highlight/Discover emerging trends and themes between callers
b. Legal
   i. Fraud investigations
   ii. Law enforcement interrogations
   iii. Legal Depositions
c. Personality detection
   i. Based on predominant (or most prevalent) emotions/sentiments
d. Education
   i. Comprehension verification in an education setting
   ii. Instructor efficacy based on sentiment
   iii. During review of disputes or conflict between parties
      1. He-said/she-said resolution or insights
e. Interview analysis (on-phone or in-person 1 real-time or post-interview)
   i. Insurance fraud prevention
   ii. Recruitment
      1. Preliminary applicant screening
   iii. Legal
      1. Law enforcement interrogations
      2. Depositions
      3. Lawyer and Client interviews
   iv. Workplace
      1. Recruitment/HR
         a. Pre-employment screening
         b. Employee Coaching/Correction tool
         i. Deceit
         ii. Loyalty
         iii. Workplace/policy violations
         1. Drug use
         2. Leaking sensitive data/information
         3. Harassment
         c. Interviewer reviews/coaching
         d. Interviewee analysis
         e. Conflict resolution
      2. Performance review analysis
      3. One-on-one coaching analysis
      4. Enforcement and review tool to support fair hiring practices
f. Individual identification
   i. KYC AML (know your customer/anti-money laundering) on-phone ID authentication
   ii. Personality detection
g. Insurance
   i. risk assessment
      1. is person/entity being insured telling the truth during application process
   ii. insurance fraud/concealment of information

An additional embodiment of the present invention is:
a. The invention connects to a phone system (VoIP preferred, but traditional copper-line systems like NEC and Avaya can be integrated
b. The invention “listens” to both channels of a phone based voice interaction
c. By tracking the flow of an interaction, Behavioral Signal Processing algorithms can determine what behaviors and emotions caused a reaction and when there were turning points.
d. These insights can then be transformed into analytic reports and eventually teaching tools, deriving true value from often-disregarded unstructured data.
e. The invention listens for emotion and intention behind an individuals' words through the pitch contour, tone, intensity, and frequency.
   iii. Frequency characteristics—this can include aspects like the shape of accents, the level of pitch and slope of contours that the speaker uses.
   iv. Time-related features—the speed at which the speaker is talking
   v. Voice quality parameters and energy descriptors—this will include features like breathlessness, pauses and loudness of the speaker.
f. The invention quantifies unstructured signal data—like speech/audio and video and translates them into visual indicators that represent the current emotion/sentiment state of parties involved and also presents one side with potential actions that can be taken to move the emotion/sentiment towards ones that are more conducive to the goals of a given project, program, or implementation.
g. The invention leverages AI and machine learning to capture emotion/sentiment insight.
h. Key technical algorithms used (based on the current interaction and existing data-sets) could potentially include:
   vi. LDC—classification of the emotion is based directly on which group it is associated to
   vii. kNN—classification of the emotion is based on the nearest result. If the algorithm cannot find an exact match, it will find the closest match or nearest neighbour as this is commonly referred to
   viii. Decision tree—a series of rules or paths work out which emotion the speech is classified into. The branches of the tree represent subsequent features.
   ix. HMMs—This uses what is known as a Markov model to work out the probability of different emotional states and is one of the most common methods in speech detection.
i. The invention uses a set of training data that has been used to provide the AI system with context for each interaction. And so, is able to categorize emotion/sentiment cues into primary (fear, anger, sadness) and secondary emotion groups (affection, pain, sympathy)
j. The training data and working (live) data are stored and used a reference point for the system in future interactions. This can be described as a data-base.
k. Dependant on the scope of an implementation, and available compute power; the invention is designed to handle thousands of analysis points on a per-minute basis.
l. The invention is a self-learning system as each interaction is used to further inform the system which over-time increases the accuracy of emotion being detected and actions being prescribed
   The invention is designed to process emotion/sentiment indicators at a frequency of 15 seconds for the duration of an interaction.

Another embodiment of the invention is short lexical expressions in conversational speech convey emotions by the speaker modifying the prosody of the utterance. It is thought that these are an unintentional kind of emotion and bring out a better result in terms of understanding the speaker as opposed to the more deliberate speech bursts

Depending on the implementation of the technology there may or may-not be a prescriptive element that tells the user what to do to move the emotion or sentiment. In some applications, the need for prescriptive actions is not needed as the technology is used as an interaction review tool.

Emotion detection is based on the prosodic elements of speech whereas prosody is concerned with those elements of speech that are not individual phonetic segments (vowels and consonants) but are properties of syllables and larger units of speech, including linguistic functions such as intonation, tone, stress, and rhythm.

While a specific embodiment has been shown and described, many variations are possible. With time, additional features may be employed.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1: A system for voice pattern recognition implementable on input voice, for extracting prosodic features of said input voice.

2: A prosody detector for carrying out a prosody detection process on extracted respective prosodic features.

3: The system listens to the intonation of the speakers and the way specific words are pronounced in order to attach a specific emotion to each tone.
a) The system as per claim 3, it tracks Behavioral Signal Processing algorithms which can determine what behaviors and emotions caused a reaction and when there were turning points.
